(19) United States
(12) Patent Application Publication
(10) Pub. No.: US 2007/0225398 A1
(43) Pub. Date: Sep. 27, 2007

(54) Concentrated Aqueous Methacrylamide Solution Comprising Methacrylic Acid

(75) Inventors: Joachim Knebel, Alsbach-Hahnlein (DE); Wolfgang Klesse, Mainz (DE); Bardo Schmitt, Mainz (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: ROEHM GMBH, Darmstadt (DE)

(21) Appl. No.: 11/587,389

(22) PCT Filed: May 20, 2005
(86) PCT No.: PCT/EP05/05466

§ 371 Date: Oct. 24, 2006

(30) Foreign Application Priority Data
Jul. 6, 2004 (DE) 10 2004 032 766.1

(51) Int. Cl. C08F 20/56; C08F 220/56; C08L 53/00

(52) U.S. Cl. 522/175; 525/329.4; 525/90

(57) ABSTRACT

The invention relates to a liquid, concentrated formulation containing methacrylamide.

### FIELD OF THE INVENTION

The invention relates to a novel and improved supply form of methacrylamide.

Hereinafter, (meth)acrylic acid is understood to mean the compounds acrylic acid and methacrylic acid and the particular derivatives.

### STATE OF THE ART

Being a polymerizable derivative of methacrylic acid, methacrylamide is known per se and commercially available (CAS No. 79-39-0). A problem in the commercial handling of methacrylamide is its tendency to form lumps and to cake in solid form and to develop fine dust. This entails complicated apparatus for the handling and metering of the material at the place of use, for example lump breakers and suction removal devices with the accompanying filters. Acrylamide has neurotoxic and carcinogenic potential and is therefore used predominantly as an aqueous solution. This avoids contamination as a result of dust formation and risks in the course of handling are distinctly reduced. Since methacrylamide too has a certain neurotoxic potential, it is desirable for this reason to provide a liquid trade and shipping form for methacrylamide too. While acrylamide has a high water solubility and is commercially available as, for example, 40-50% solution, methacrylamide is soluble in water at 20° C. only to an extent of approx. 20% by weight.

To date, methacrylamide, in order to avoid the dust problem and the problem of lump formation in the solid formulation, has been traded in the form of a 15% by weight aqueous solution, since only approx. 25 g of monomer dissolve per 100 g of water at 20° C. The concentration of methacrylamide in H₂O is quite low, so that a comparatively large amount of water as a solvent has to be shipped. Moreover, such a large water content may be undesired in certain polymerizations.

### OBJECT

It is thus an object of the invention to develop a shipping and commercial form for methacrylamide which
avoids the handling disadvantages of crystalline methacrylamide,
is easy for the customer to use and entails a low level of or, if at all possible, no switchover complexity,
and has a higher content of methacrylamide as a polymerizable compound.

### SOLUTION

It has now been found that use of aqueous (meth)acrylic acid succeeds in dissolving up to 67 g of methacrylamide in 100 g of solvent mixture.

| Water | (Meth)acrylic acid | Methacrylamide |
|---|---|---|
| 0 | 100 | 54 |
| 5 | 95 | 58 |
| 33 | 67 | 67 |
| 50 | 50 | 67 |
| 58 | 42 | 67 |
| 67 | 33 | 67 |
| 80 | 20 | 40 |
| 100 | 0 | 25 |

(parts by weight, at 20° C.)

| Water | Acrylic acid | Methacrylamide |
|---|---|---|
| 0 | 100 | 66 |
| 5 | 95 | 66 |
| 33 | 67 | 67 |
| 50 | 50 | 67 |
| 58 | 42 | 67 |
| 67 | 33 | 67 |
| 84 | 16 | 49 |
| 100 | 0 | 25 |

(parts by weight, at 20° C.)

The values in the table show that the replacement of one part of the water by (meth)acrylic acid leads to a distinct increase in the amount of methacrylamide soluble in the solvent mixture of water and (meth)acrylic acid.

The inventive solution can be used directly as a raw material mixture to prepare polymers and/or copolymers when these polymers simultaneously contain (meth)acrylic acid as a comonomer. Possible polymerization processes are emulsion polymerization, suspension polymerization or polymerization in solution. Since methacrylamide, especially in the case of emulsion polymerization, the most important field of use for methacrylamide, is usually used in combination with methacrylic acid, the concentrated methacrylamide solutions in water/(meth)acrylic acid are suitable for a majority of the existing applications. This is especially true when the (meth)acrylic acid content in the concentrated aqueous supply form is less than the methacrylamide content. The weight ratio of methacrylamide:(meth)acrylic acid is preferably at least 2:1, more preferably at least 3:1.

The selected methacrylamide concentration of the supply form is guided by the demands which are made on the cold stability of the solution. When crystallization is to be prevented at lower temperatures than room temperature, a lower concentration than the maximum possible 44 g in 100 ml of water/methacrylic acid mixture at room temperature will be set. The methacrylamide content of the solution is preferably at least 25% by weight, more preferably at least 30% by weight and in particular at least 35% by weight.

In order to prevent undesired premature polymerization, the solution is generally admixed with customary stabilizers. These include phenols such as hydroquinone and hydroquinone monomethyl ether, but also Cu⁺⁺-ions. Preference is given to hydroquinone monomethyl ether and Cu⁺⁺-ions.

1. An aqueous solution of methacrylamide,
characterized in that
it comprises, to increase the solubility of the methacrylamide, 5-65% by weight, based on the amount of solvent, of (meth)acrylic acid.

2. The aqueous solution as claimed in claim 1,
characterized in that
the methacrylamide content of the solution is at least 25% by weight.

3. The aqueous solution as claimed in claim 1,
characterized in that
the methacrylamide content of the solution is at least 30% by weight.

4. The aqueous solution as claimed in claim 1,
characterized in that
the methacrylamide content of the solution is at least 35% by weight.

5. The aqueous solution as claimed in claim 1,
characterized in that
the weight ratio of methacrylamide to (meth)acrylic acid is at least 2:1.

6. The aqueous solution as claimed in claim 1,
characterized in that
the weight ratio of methacrylamide to (meth)acrylic acid is at least 3:1.

7. The method of using the solution as claimed in claim 1 for preparing polymers.

8. A polymer obtainable by polymerization or copolymerization of the solution as claimed in claim 1.
